(19) United States
(12) Patent Application Publication
(10) Pub. No.: US 2005/0289011 A1
(43) Pub. Date: Dec. 29, 2005

(54) Method and system for purchasing copyrighted digital data from independent sales parties

(75) Inventor: Manushantha Sporny, Blacksburg, VA (US)

Correspondence Address: DIEDERIKS & WHITELAW, PLC, 12471 Dillingham Square, #301, Woodbridge, VA, 22192, US

(73) Assignee: DIGITAL BAZAR, INC., Blacksburg, VA (US)

(21) Appl. No.: 10/709,819

(22) Filed: May 31, 2004

Related U.S. Application Data
(60) Provisional application No. 60/481,016, filed on Jun. 24, 2003.

(51) Int. Cl. G06Q 30/00

(52) U.S. Cl. 705/26

(57) ABSTRACT

A Secure File Distribution Network (SFDN) method and computer system allows copyrighted digital works to be sold securely by independent sales parties and ensures that all creators and distributors of the work are paid all royalties and fees owed to them, regardless of who is selling the work. A verification authority tracks all buyers, sellers and digital works being traded on the file sales network, matches buyers with sellers, and provides a digital works search service for users of the system. Once a digital work is located in a desired media format, and at an attractive price, a buyer and seller can negotiate a secure transaction. Once the transaction is completed using the SFDN, the verification authority distributes payments to the seller and all creators involved in a particular work. Thus the SFDN provides content creators security in earning a living while not impinging on consumer's fair use rights.

### CROSS REFERENCE To RELATED APPLICATIONS

This application claims the benefit of U.S Provisional Application No. 60/481,016 filed Jun. 24, 2003.

### BACKGROUND OF INVENTION

Digital media e-commerce is a fairly new economic medium and is currently threatened by software piracy. Recent legislative changes, such as the Digital Millennium Copyright Act of 1998, the extension of copyright protection, and the increasing support for digital rights management, all underscore the importance of digital media sales in our future economy. The greatest obstacle to the digital media industry is the development of a secure, online, primary and secondary marketplace that protects the creator's intellectual property. This is due to the fact that making exact copies of any digital media is effortless and requires no attention to appropriate royalty reimbursement. The solution is a network that simultaneously protects and remunerates the intellectual property owners and acknowledges the rights of producers to be fairly compensated in the primary market, yet allows consumers the equal right to benefit from sales in the secondary market.

It is estimated that the U.S. film industry loses more than $3 B in revenue per year due to piracy, while the U.S. music industry loses more than $4 B annually. Clearly, piracy is a significant concern to content producers. The introduction of digital media and high-speed networks has aided the spread of piracy from an underground culture to a popculture, with an average of three million people illegally trading copyrighted works at any given time. This proliferation of digital music piracy resulted in damages in excess of $1 B during 2002.

Since the creation of file-sharing networks such as Napster, Kazaa, Morpheus, Gnutella, and LimeWire, digital content creators have been fighting an increasingly difficult battle against digital piracy. The Recording Industry Association of America (RIAA) and the Motion Picture Association of America (MPAA) represent content creators who are concerned about the protection of their creative works, while various corporations such as Napster, Inc., Kazaa and StreamCast Networks, Inc. represent file-sharing systems that enable customers to share any media they wish. Both sides are desperately struggling for their respective positions with no meaningful solution to the piracy problem in sight (2003). Meanwhile, consumers are harmed by recent legislation passed in response to pervasive digital piracy. Increasingly restrictive fair-use rights, digital rights management initiatives, and trusted computing initiatives restrict a consumer's option to truly utilize all the privileges of ownership to a purchased digital device or work.

Most parties involved in digital media and the entertainment industries suggest that the flashpoint for digital piracy was the invention of the MP3 file format and the Napster file-sharing network. In the early 1990s, when the Internet was just beginning its meteoric rise into mainstream culture, transferring media files from computer to computer was cost prohibitive. Streaming media compression formats for multi-media had not reached widespread use; most media files were too large for the delivery medium. Equally important was the quality of most compression formats, which were not as robust as formats available today.

The MP3 file format was patented in 1989 by Fraunhofer-Gesellschaft and Thompson Multimedia. It did not gain widespread acceptance as a streaming sound file format until 1997. At the same time, CDs were becoming the most popular sales medium for music, providing crystal clear playback in a format that would not degrade over time. These digital audio files were often quite large (e.g., a 5 minute song could require more than 40 megabytes), far too large to download in a reasonable amount of time even using today's standards. The subsequent MP3 format allowed a consumer to encode the 40-megabyte CD file into an MP3, which might be only 5 megabytes in size. The MP3 could then be decoded using a media player, producing a sound almost acoustically indistinguishable from the original. It was this breakthrough that made audio transfer and piracy feasible using low-bandwidth Internet connections.

Many computer-savvy music listeners started digitizing their entire music collections, which offered the convenience of accessing their entire music collection without having to search through a stack of plastic CDs. Some listeners started to illegally trade their music over the Internet. However, the digital music piracy problem became epidemic when the first generation of file sharing applications started operating in late 1997. The most notorious of these was Napster.

Napster is reviled by the professional digital content industry due to the mass-scale piracy movement that it started. While file-sharing networks fundamentally enhance freedom of expression, they also provide a mass conduit for piracy due to the anonymous nature of transactions. Napster was well aware that its networks were allegedly being used for piracy, and could have stopped it, yet did not attempt to do so. At its height, the file trading network had over 70 million unique users and facilitated more than 3 billion file downloads per month, most of which have been alleged as pirated material. So, what made Napster such an effective application? The core benefit of any file-sharing network is that it enables relatively fast searches across the contents on the sharing network. A file-sharing network usually consists of millions of computers with a combined file pool of billions of files. The summed storage space and bandwidth availability of the combined systems are far greater than most large corporations could ever support. A user of the Napster system could search for a song encoded in the MP3 format and, within minutes, download it anonymously without paying a fee for the service or royalties for the downloaded file. Users could share their entire music collection and anonymously trade with others, resulting in the single largest, publicly-accessible database for music ever created.

The fruits of this new file-sharing network have been countless lawsuits over intellectual property rights, freedom of expression, digital piracy and consumer content ownership. These battles continue today, where the second generation of file-sharing networks, such as Kazaa, Grokster, Morpheus and others, have subsequently failed due to mass piracy on their networks, resulting in litigation by the RIAA and the MPAA. The digital content industries have chosen to solve the problem in several ways: litigation threats and action, consumer copyright education, digital guerilla warfare, intellectual property (IP) protection legislation, digital rights management, and more secure computing initiatives. While some of these initiatives are needed and on target, the industry's main focus in curbing digital piracy maybe misguided, in that some of these initiatives have done more harm than good. Consumers have become increasingly concerned with the strategies of both the RIAA and MPAA, with some consumers reacting quite negatively to the infringement of their fair-use rights. The technology protection that content companies (i.e. those who produce digital media) are seeking is not likely to stop piracy or to be accepted by mainstream consumers. In fact, there has never been a digital rights management system that could not be bypassed. Piracy on this scale is a social problem just as much as it is a technological and financial problem. Thus any solution must be approached from social as well as financial and technological perspectives.

### SUMMARY OF INVENTION

I have invented a method and computer system that allows copyrighted digital data to be sold securely by independent sales parties. The system, referred to as the Secure File Distribution Network (SFDN), ensures that all creators and distributors of the copyrighted digital data are paid all royalties and fees owed to them, regardless of who is selling the copyrighted digital data and without damaging their fair-use rights. There are three parties that participate in any transaction in the system; the Verification Authority (VA), a seller, and a buyer. The VA is responsible for keeping track of all buyers, sellers and merchantable works being traded on the file sales network. A merchantable work is described as any copyrighted digital work that is being sold on the file sales network. The VA is responsible for matching buyers with sellers and providing a search service for users of the system so that merchantable works can be found easily. Once a merchantable work is located in the desired media format, and at an attractive price point a buyer and seller can negotiate a secure transaction. Once the secure transaction is completed (ie: a buyer has the digital media purchased), the VA will distribute payments to the seller and all creators involved in a particular work.

### BRIEF DESCRIPTION OF DRAWINGS

FIG. 1 is a drawing of the core components of the invention.

FIG. 2 is an example of a merchantable work being registered with the sharing network.

FIG. 3 is an example of a seller registering with the sharing network.

FIG. 4 is an example of a buyer registering with the sharing network.

FIG. 5 is an example of a seller providing a list of merchantable works they are selling.

FIG. 6 is an example of a buyer performing a simple search for a merchantable work.

FIG. 7 is a sample technical system-level view of a simple merchantable work purchase.

FIG. 8 is a sample financial system-level view of a simple merchantable work purchase.

### DETAILED DESCRIPTION

Others have created digital file sales mechanisms, also known as e-commerce applications, peer-to-peer file sharing networks, micro-payment applications and variations and combinations of the previously mentioned systems, my invention is superior because:
The system solves a very serious problem in the digital content creation and sales industries; namely the sale, distribution and royalty disbursement of purely digital, copyrighted media.
The system is based on consumer and seller trust and reputation; users are not anonymous on the system and thus have a strong obligation to not pirate material.
The core of the system is very flexible and does not depend on digital rights management technology and allows both the buyers and sellers to choose the most favorable media format.
Buyers can be sellers as well without needing a special license for any of the material on the network, which also gives them a financial incentive to become part of the digital media distribution process.
The system allows copyright owners to have full control over how their works can be distributed, who can distribute them, as well as each merchantable royalty scheme.
The system protects consumers fair use rights while providing the maximum financial and distribution benefit for creators.
The system allows each buyer and seller application of the system to be created by an independent party. The system may also protect users from untrustworthy buyers and sellers by providing a rating for each buyer and seller in the system.
There is a central, trusted authority that is responsible for all financial transactions while the distribution mechanism for the set of merchantable works is distributed and quite dynamic, thus security of financial transactions are ensured while providing the maximum possible distribution bandwidth.

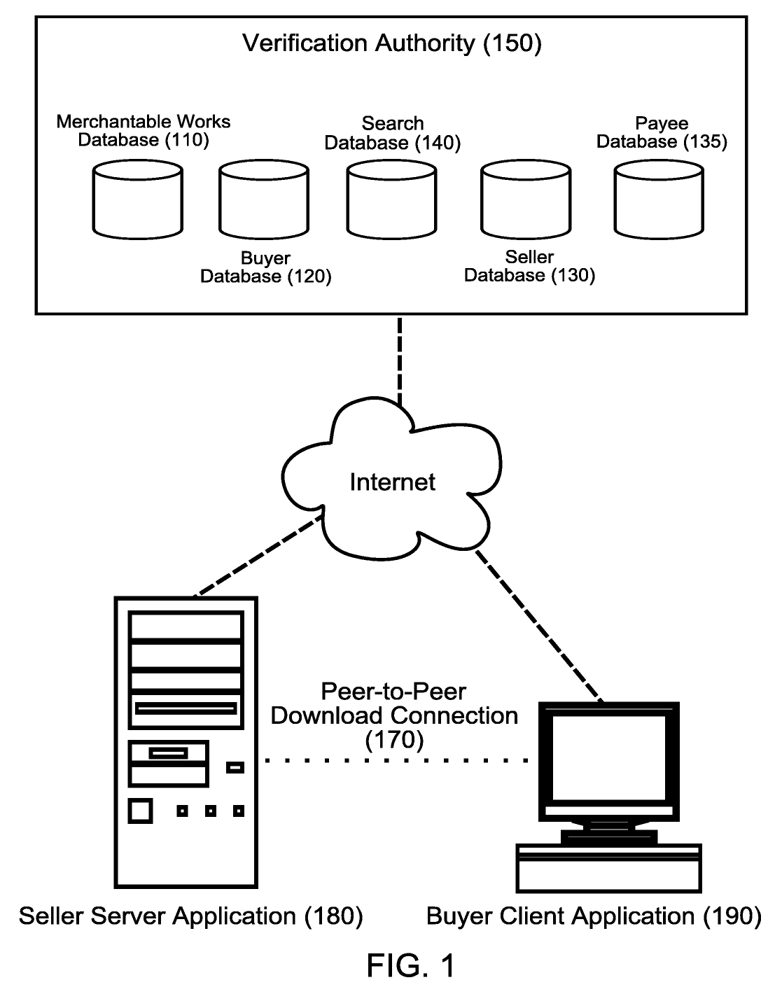

FIG. 1 depicts the core components of the system. The Verification Authority 150 is at the core of the file sales network, it verifies each transaction and ensures that all parties involved get their agreed upon royalty and fee payments. A Merchantable Works Database 110, is used to store information about each merchantable work that is sellable on the file sales network. Each Merchantable Work may include author/artist, date of creation, royalty scheme, royalty payees, allowable file formats, allowable distributors, and other such merchantable work information. A Buyer Database 120, is used to store information about each buyer account in the file sales network. A buyer account is composed of the buyer's name, ID, account balance, and may include other items like transaction history, trustworthiness rating, buying preferences, and contact information. A Seller Database 130, is used to store information about each seller account in the file sales network. A seller account is composed of a seller's name, ID, account balance, real-world bank account number along with other banking related information, and may include other items such as transaction history, trustworthiness rating, selling preferences, seller rating and contact information. A Payee Database 135, is used to store information about each Payee Account 830 in the file sales network. A Payee Account 830 is composed of a payee's name, ID, and account balance and may include other items such as transaction history, banking related information, and contact information. Artists, producers, and other such entities not involved in file transactions on the SFDN would use Payee Accounts 830 on the system. A Search Database 140, which associates merchantable works with the Seller Server Applications 180 that are providing the files in such a way as to make searching all available merchantable work files faster and more precise. Other information may be placed in the Search Database to improve search performance and precision. Information and indexes such as most popular works, independent works, media type, royalty scheme, media genre, cost and other search criteria are taken into account when building the search database. The collective system that these databases are a part of is called the Verification Authority 150 and may reside on one or multiple servers on a communications network as a single or distributed computer system.

FIG. 1 also illustrates two other main components of the file sales network. The Seller Server Application 180, and the Buyer Client Application 190. The Seller Server Application 180 is responsible for providing a set of merchantable works that may be purchased via the Verification Authority 150 by a Buyer Client Application 190. Merchantable work files registered by the Seller Server Application 180 are indexed in the Search Database 140. A Buyer Client Application 190 can then perform a search for a particular merchantable work via the Verification Authority 150, which in turn utilizes the Search Database 140 to return a list of Seller Server Applications 180 that are hosting the file for purchase. A merchantable work file transaction may then occur over the Peer-to-Peer Connection 170, a process that will be discussed later in the document.

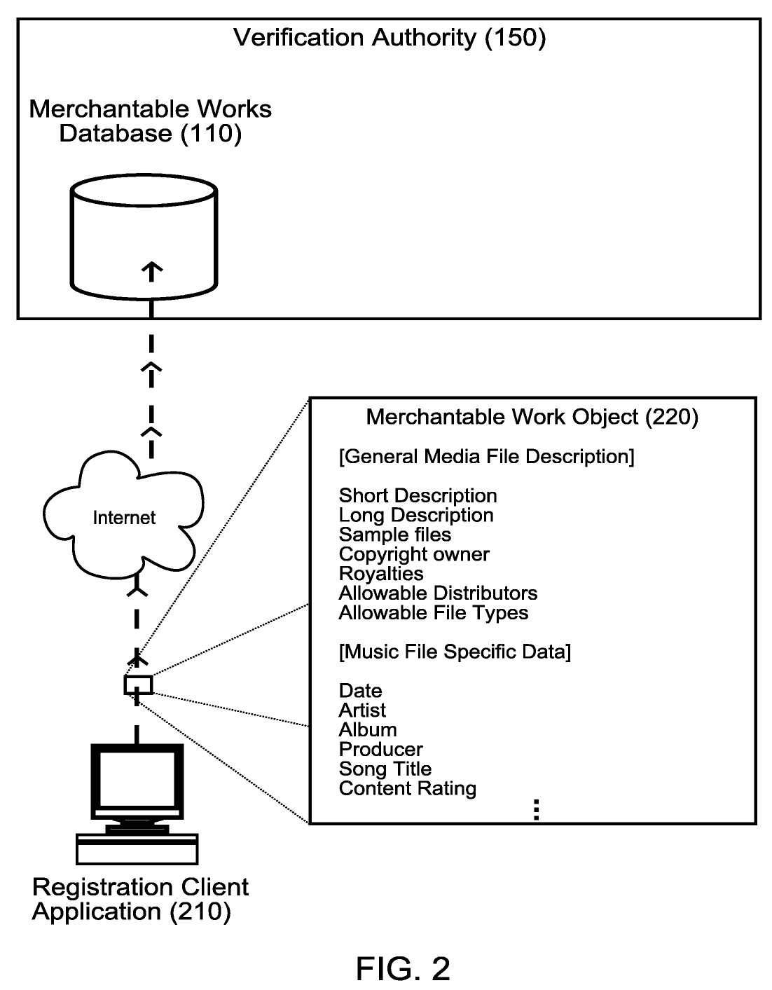

FIG. 2 depicts the process of registering a Merchantable Work Object 220 with the Verification Authority 150. In this process, a Registration Client Application 210 contacts the Verification Authority 150 and transmits a message containing a Merchantable Work Object 220 to be stored in the Merchantable Works Database 110. A Merchantable Work Object 220 consists of a general media file description and optional media specific information. For example, a Merchantable Work Object for a song would contain at least the following general media file description items; description, copyright owner, list of royalty payees, list of allowable distributors. The music specific information would contain at least the following music media file description items; artist, album, song title, allowable file formats. The Verification Authority 150 upon receiving the message, will process it and if the request is a valid one, insert the Merchantable Work Object 220 into the Merchantable Works Database 110. The process of deciding if a message is valid may be internal (automatically processed) or external (processed by an authoritative human being working on behalf of the Verification Authority 150) process. If the validity check is a success, the Merchantable Work Object 220 becomes inserted into the Merchantable Works Database 110.

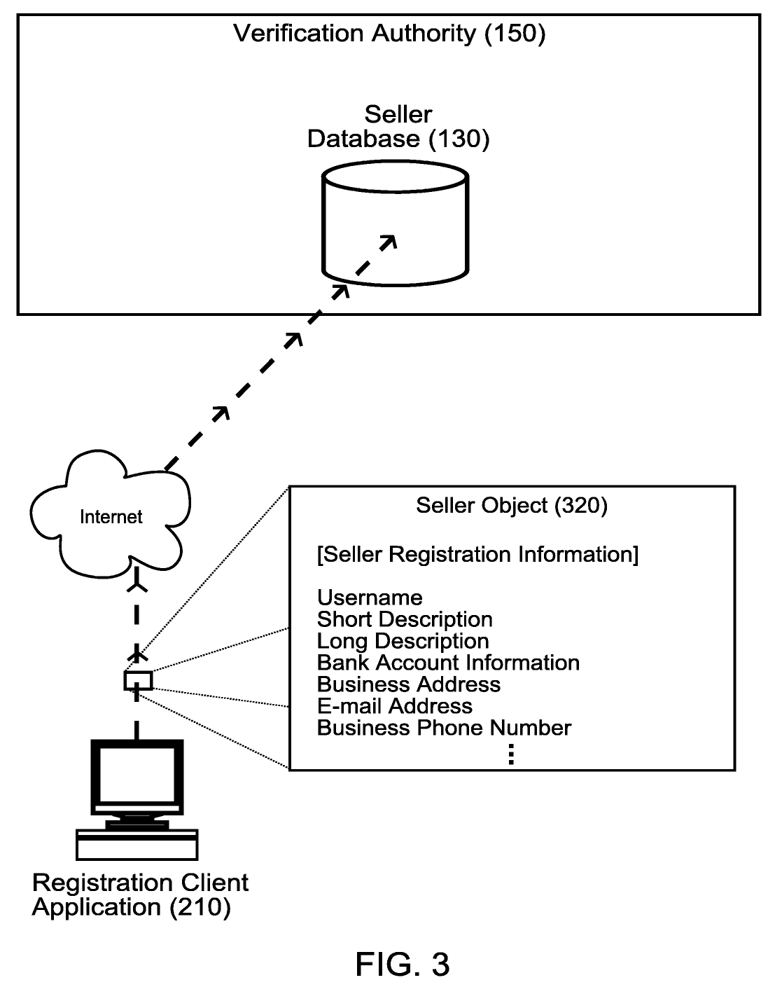

FIG. 3 demonstrates the process of registering a Seller Object 320 with the Verification Authority 150. In this process, a Registration Client Application 210 contacts the Verification Authority 150 and transmits a message containing a Seller Object 320 to be stored in the Seller Database 130. A Seller Object 320 consists of information relating to a real-world entity such as a person or legal entity that wishes to sell digital media on the Secure File Distribution Network. For example, a Seller Object 320 would contain at least the following seller description items; username, password, entity name, and e-mail address. A bank account number would be required at a later time if the user wished to transfer their funds out of the Verification Authority 150 system. After the Seller Object 320 has been transmitted to the Verification Authority 150, the contents are checked for validity by an internal (automatically processed) or external (processed by an authoritative entity working on behalf of the Verification Authority 150) entity. If the validity check is a success, the Seller Object 320 becomes inserted into the Seller Database 130. The Seller Object 320 information may then be used by the authorized seller to distribute and charge for digital media downloads.

The process for registering a Payee Object with the Verification Authority 150 is very similar to registering a Seller Object 320 (described in FIG. 3). In this process, a Registration Client Application 210 contacts the Verification Authority 150 and transmits a message containing a Payee Object to be stored in the Payee Database 135. A Payee Object consists of information relating to a real-world entity such as a person or legal entity that should be reimbursed for works sold on the Secure File Distribution Network. For example, a Payee Object would contain at least the following payee description items: username, password, entity name and e-mail address. A bank account number would be required at a later time if the payee wished to transfer their funds out of the Verification Authority 150. After the Payee Object has been transmitted to the Verification Authority 150, the contents are checked for validity by an internal (automatically processed) or external (processed by an authoritative entity working on behalf of the Verification Authority 150) entity. If the validity check is a success, the Payee Object becomes inserted into the Payee Database 135. The Payee Object information may then be used by merchantable works to define royalty amounts and payees.

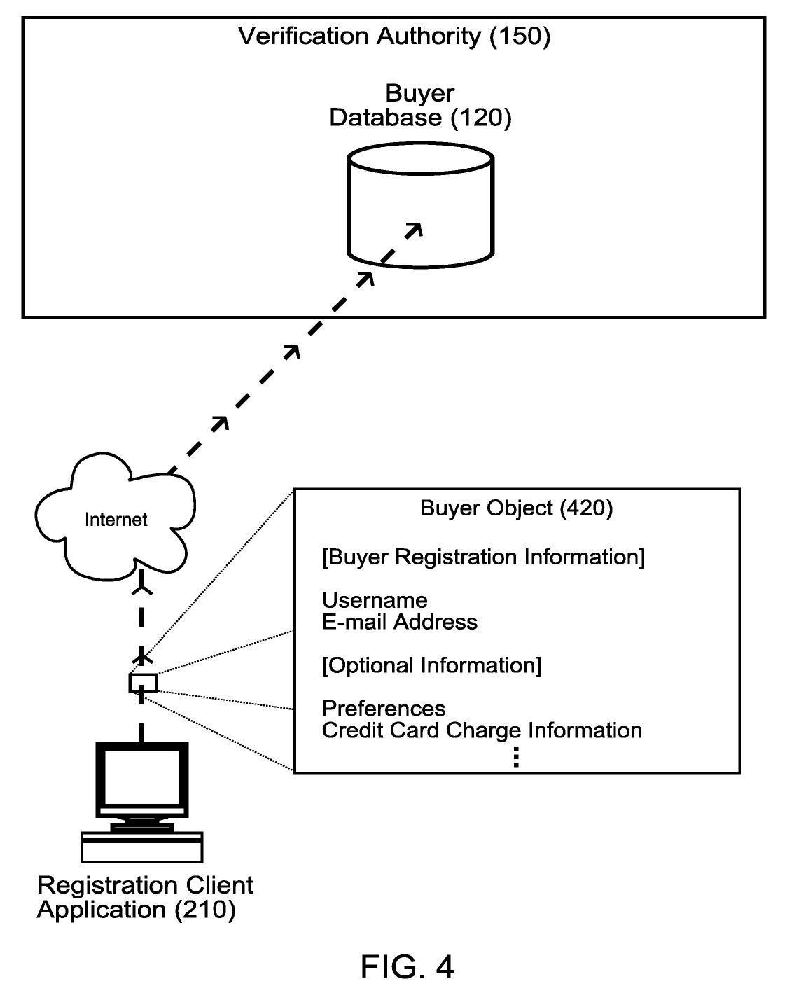

FIG. 4 illustrates the steps involved in registering a Buyer Object 420 with the Verification Authority 150. This process is quite similar in nature to registering a Seller Object 320 or Payee Object. In this process, a Registration Client Application 210 contacts the Verification Authority 150 and transmits a message containing a Buyer Object 420 to be stored in the Buyer Database 120. A Buyer Object 420 consists of information relating to a real-world entity such as a person or legal entity that wishes to buy digital media on the Secure File Distribution Network. For example, a Buyer Object 420 would contain at least the following buyer description items; username, password, entity name and e-mail address. After the Buyer Object 420 has been transmitted to the Verification Authority 150, the contents are checked for validity by an internal (automatically processed) or external (processed by an authoritative entity working on behalf of the Verification Authority 150) entity. If the validity check is a success, the Buyer Object 420 becomes inserted into the Buyer Database 120. The Buyer Object may then be charged via bank card, credit card or other form of funds transfer to credit the account with a cash basis to purchase digital media.

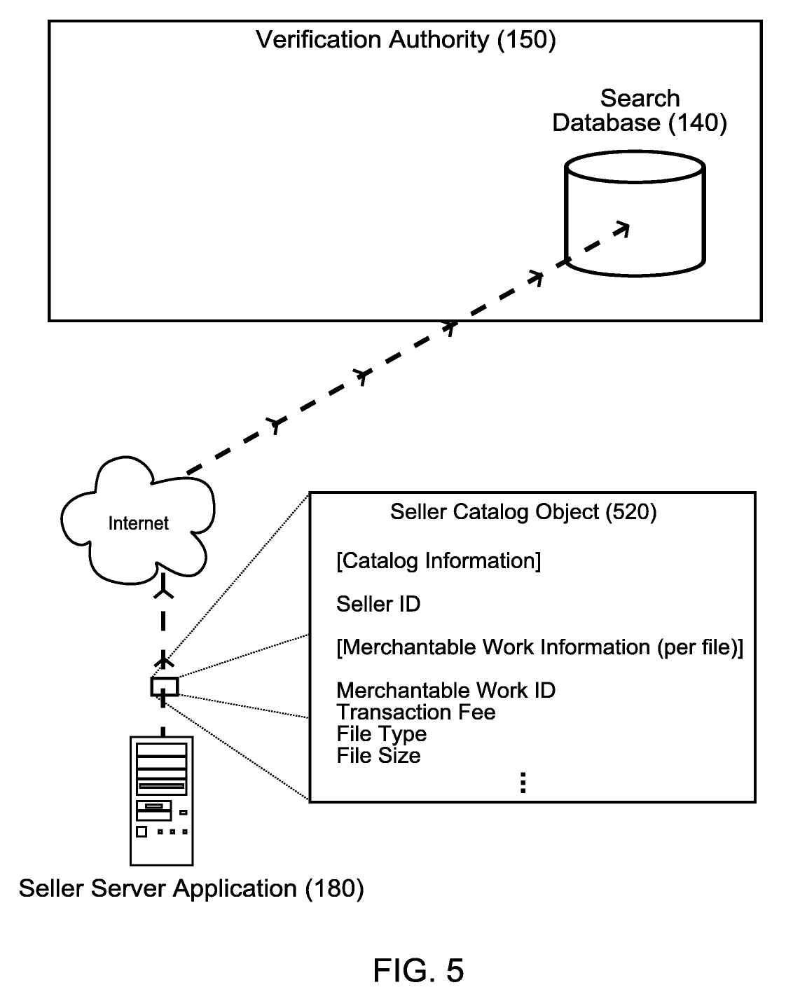

FIG. 5 is a overview of the seller registering a group of merchantable works that they are offering to the Secure File Distribution Network. Once a seller has registered themselves with the Verification Authority 150, described in FIG. 3, they must provide a list of merchantable works they are offering to the Secure File Distribution Network. In this process, a Seller Server Application 180 contacts the Verification Authority 150 and transmits a message containing a Seller Catalog Object 520 to be stored in the Search Database 140. A Seller Catalog Object 520 consists of information relating to a subset of, or the whole file catalog that the Seller Server Application 180 is offering for purchase. The Seller Catalog Object 520 consists of at least a Seller Identification Number (which is assigned through the process described in FIG. 3) and a list of files, where each file must have at least a Merchantable Work Identifier (which is assigned through the process described in FIG. 2) and may optionally have other information such as, but not limited to; transaction fee, file type, and file size. After the Seller Catalog Object 520 has been transmitted to the Verification Authority 150, the contents are checked for validity by an internal (automatically processed) or external (processed by an authoritative entity working on behalf of the Verification Authority 150) entity. If the validity check is a success, the Seller Catalog Object 520 is merged into the network-wide search information in the Search Database 140.

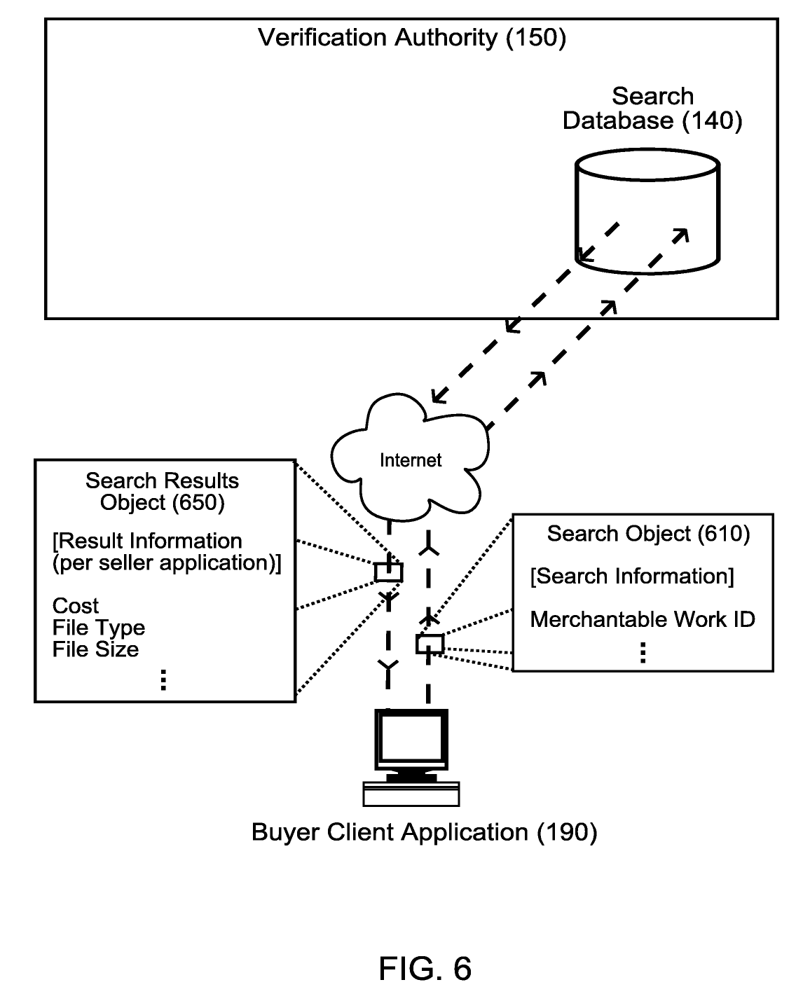

FIG. 6 outlines the process of searching for a particular merchantable work on the Secure File Distribution Network. In this process, the Buyer Client Application 190 transmits a message to the Verification Authority 150 containing a Search Object 610. The Search Object 610 must contain at least one merchantable work identifier. The Verification Authority 150 can provide a simple method of searching for merchantable work identifiers based on any information that is contained in the merchantable work identifier. The Verification Authority 150 can provide a simple method of searching for merchantable work identifiers based on any information that is contained in the Merchantable Work Object 220. For example, a web browser can access the Verification Authority 150 via a web page and perform a search for a particular artist and song. The search results would return, a list of merchantable works that match the search criteria. The user may then pick a particular merchantable work item to discover its merchantable work identifier.

The Verification Authority 150 performs a search using the Search Database 140 and returns a Search Results Object 650 to the Buyer Client Application 190. The Search Results Object 650 contains a list of Seller Server Applications 180 that are offering files associated with the given merchantable work identifier. For each Seller Server Application 180, a list of files is given that matches the merchantable work identifier. For each file a seller fee, file type, file size and other such information may be included to aid the buyer in deciding from which Seller Server Application 180 to purchase the merchantable work file.

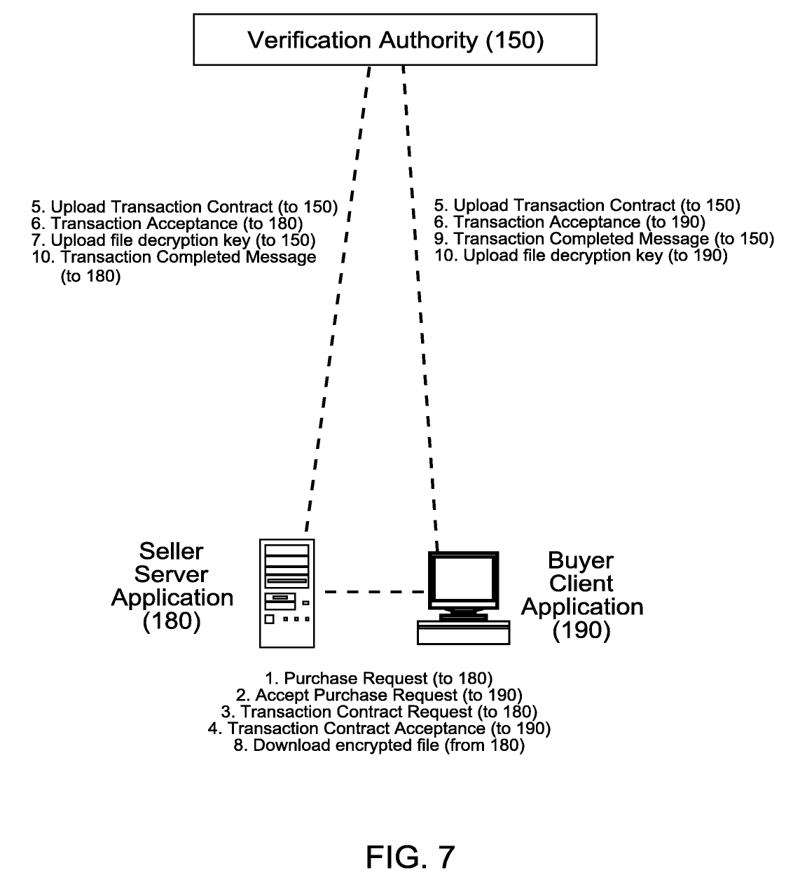

FIG. 7 illustrates a system-level view of the merchantable work negotiation, transfer and purchase process. Each step in the process is denoted by the leading number, some steps may occur simultaneously or at approximately the same time, in which case they are numbered identically. The process is described in detail below:

Step 1: The first part of the merchantable work purchase process involves the Buyer Client Application 190 notifying the Seller Server Application 180 that it wishes to purchase a merchantable work file.

Step 2: The Seller Server Application 180 then notifies the Buyer Client Application 190 that it may continue with the purchase request. The Seller Server Application 180 can deny the Buyer Client Application 190 from purchasing the file from it at this point as well.

Step 3: Upon acceptance of the purchase request from the Seller Server Application 180, the Buyer Client Application 190 will then send a Transaction Contract Request to the Seller Server Application 180. The Transaction Contract Request will contain the merchantable work being purchased, an itemized list of costs summing to a total price, and may contain other negotiated values such as an average bandwidth rate agreement.

Step 4: The Seller Server Application 180 may then accept or reject the Transaction Contract. If the contract is rejected, steps 3 and 4 may be repeated until either party stops responding.

Step 5: Once the contract is accepted, both the Buyer Client Application 190 and the Seller Server Application 180 upload the agreed upon transaction contract to the Verification Authority 150. The Verification Authority 150 temporarily stores the transaction contract for the duration of the purchase process.

Step 6: The Verification Authority 150 notifies both the Buyer Client Application 190 and the Seller Server Application 180 that the transaction contract has been accepted or rejected. On the rare occasion that a transaction contract is rejected, the Buyer Client Application 190 and Seller Server Application 180 may resubmit a more compliant transaction contract.

Step 7: The Seller Server Application 180 may optionally tag the file being sold with an internal (contained in the file meta-data) or external (as a separate file) digital receipt of sale using a public digital signature method such as the Digital Signature Standard (DSA). The file may be processed further to personalize the data to the buyer (for example: adding digital rights management tags, modifying an internal watermark or image, or processing the digital data in any way as to provide a more personalized digital file for the buyer). The file is then optionally encrypted using a standard encryption method (for example: GNU Pretty Good Privacy using RSA or ElGamal encryption methods) and the decryption key is sent to the Verification Authority 150 for safe keeping. The file may optionally not be encrypted, in which case a blank decryption key is uploaded to the Verification Authority 150.

Step 8: Once the file has been encrypted and decryption key uploaded, the Seller Server Application 180 notifies the Buyer Client Application 190 that it may download the encrypted file. The Buyer Client Application 190 then proceeds to download the file.

Step 9: Upon completing the file download, the Buyer Client Application 190 notifies the Verification Authority 150 that it has completed the download. The Verification Authority 150 completes the transaction by transferring the agreed upon costs in the Transaction Contract to each one of the payees and seller accounts.

Step 10: The decryption key is then downloaded by the Buyer Client Application 190. The Buyer Client Application 190 then decrypts the file by using the downloaded decryption key.

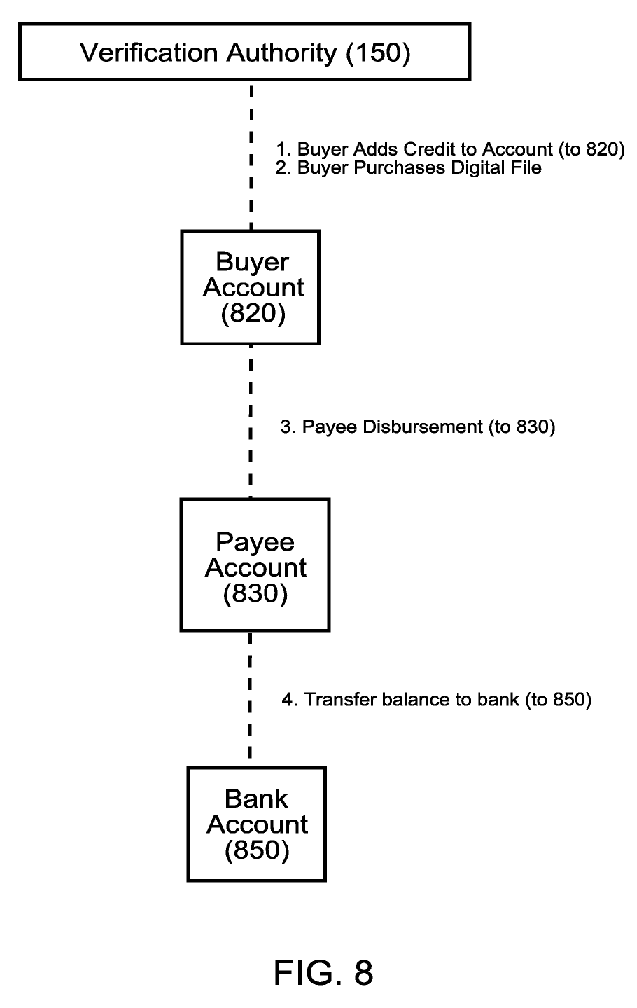

FIG. 8 depicts a financial-level view of cash flow through the described system. All money in the system originates from buyer accounts and eventually is transferred to payee and seller accounts. A buyer in the system may have one or more payee and seller accounts as well, in which case money may be transferred between the various accounts. The steps of a purchase are as follows:

Step 1: The buyer contacts the Verification Authority 150 charges their Buyer Account 820 using a credit card, debit card or other monetary transfer method. The Verification Authority 150 processes the charge transaction and credits the Buyer Account 820 with the appropriate amount of funds.

Step 2: The buyer purchases a merchantable work on the system (described in FIG. 7).

Step 3: The payment approved by the buyer is transferred into each Payee Account 830 that should receive payment for the merchantable work. There can be multiple payees for each merchantable work. The details of the transaction fees are encapsulated in the transaction contract, which is affected by the merchantable work object on the Verification Authority 150.

Step 4: Money may accrue in the Payee Account 830 until the payee decides to transfer it to another bank account. Each Payee may have one or more verified Bank Account(s) 850 and may transfer the balance of their account from their Payee Account 830 to their Bank Account 850

While this description concerns a detailed, complete system, it employs many inventive concepts, each of which is believed patentable apart from the system as a whole. The use of sequential numbering to distinguish the methods employed is used for descriptive purposes only, and is not meant to imply that a user must proceed from one method to another in a serial or linear manner.

In view of the many different embodiments to which the above-described inventive concepts may be applied, it should be recognized that the detailed embodiments are illustrative only and should not be taken as limiting the scope of my invention. Rather, I claim as my invention all modifications as come within the scope and spirit of following claims, and equivalents thereto.

### REFERENCE NUMERALS

Reference numerals for the invention are given below

Reference Numerals

| | |
|---|---|
| 110 | Merchantable Works Database |
| 120 | Buyer Database |
| 130 | Seller Database |
| 135 | Payee Database |
| 140 | Search Database |
| 150 | Verification Authority |
| 170 | Peer-to-peer Download Connection |
| 180 | Seller Server Application |
| 190 | Buyer Client Application |
| 210 | Registration Client Application |
| 220 | Merchantable Work Object |
| 320 | Seller Object |
| 420 | Buyer Object |
| 520 | Seller Catalog Object |
| 610 | Search Object |
| 650 | Search Results Object |
| 820 | Buyer Account |
| 830 | Payee Account |
| 850 | Bank Account |

Operation

The initial setup on the file sales network consists of:
A sale account is created by a seller on the Verification Authority
A buyer account is created by a buyer on the Verification Authority
A merchantable work identity is created on the Verification Authority by a user of the system
A seller registers their merchantable work, or set of merchantable works, with the Verification Authority

A transaction on the file sales network consists of:

Step 1: A buyer searches for a particular merchantable work via the Verification Authority.

Step 2: A buyer receives a set of sellers and associated costs for each seller for the merchantable work from the Verification Authority.

Step 3: The buyer notifies a seller on the intent to purchase a merchantable work.

Step 4: The buyer and seller negotiate on several aspects of the transaction and create a transaction contract, which is registered with the Verification Authority.

Step 5: The buyer downloads an encrypted version of the merchantable work, the seller uploads the decryption key to the Verification Authority.

Step 6: The buyer finishes the download, notifies the Verification Authority, which then gives the buyer the decryption key in exchange for funds transfer from the buyers account to all royalty and fee parties associated with the merchantable work.

1. I claim:
A computing system using a plurality of data processors and a communication network to sell a plurality of merchantable work by way of a digital transaction, comprising:
(a) a user database composed of a plurality of user accounts for indexing a plurality of participants on said communication network,
(b) a merchantable work database composed of a plurality of merchantable works for indexing said merchantable works on said communication network,
(c) a plurality of buyer data processors connected to said communication network,
(d) a plurality of seller data processors connected to said communication network,
(e) a search database composed of a plurality of merchantable works with pricing information offered by said seller data processors for indexing all available said merchantable works for sale on said communication network,
(f) a verification authority consisting of a plurality of trusted data processors for performing searches for said merchantable works and processing sales between said participants connected to said communication network, whereby said seller data processor can register said merchantable works associated with a physical file with said search database via said verification authority, and whereby said seller data processor can register pricing information for said physical file associated with said merchantable work via said verification authority,
whereby said buyer data processor can search for said merchantable works on said communication network via said verification authority, and
whereby said buyer data processor can purchase a merchantable work from said seller data processor via said verification authority which distributes payment into each participant account associated with said transaction, and
whereby a file representing said merchantable work is transfered from said seller data processor to said buyer data processor during said transaction, and
whereby said buyer data processor may re-sell said physical file representing said merchantable work on said communication network by operating as said seller data processor.

2. The computing system of claim 1 further comprising:
(a) a seller database composed of a plurality of seller accounts for indexing sellers connected to said communication network,
(b) a buyer database composed of a plurality of buyer accounts for indexing buyers connected to said communication network,
(c) a payee database composed of a plurality of payee accounts for indexing payees connected to said communication network,
whereby the roles of said participants on the network may be identified via the database they are contained within.

3. The computing system of claim 2 wherein said file representing said merchantable work is accompanied with an internally embedded (watermarked), digitally signed, receipt of sale containing identifying information for said buyer data processor and said seller data processor, whereby said buyer is incentivized not to re-distribute said file via another communication network.

4. The computing system of claim 3 wherein said file representing said merchantable work is encrypted during transmission to the buyer data processor while said seller data processor uploads a decryption key for the encrypted file to said verification authority,
whereby said buyer data processor must pay said seller data processor before accepting said decryption key.

5. The computing system of claim 4 wherein said physical file representing said merchantable work is cleared of previous said receipt of sale before a current receipt of sale is embedded,
whereby said buyer data processor is incentivized to re-distribute said file as said seller data processor via a compatible communication network.

6. The computing system of claim 5 wherein said file associated with said merchantable work is an audio file.

7. The computing system of claim 5 wherein said file associated with said merchantable work is a video file.

8. The computing system of claim 5 wherein said file associated with said merchantable work is a binary executable computer program.

9. The computing system of claim 5 wherein said file associated with said merchantable work is a an electronic book.

10. The computing system of claim 5 wherein said file associated with said merchantable work is a visual image or picture.

11. A method of securely purchasing and re-selling digitally copyrighted works on a computer file network comprising:
(a) creation of a plurality of seller accounts on a verification authority system,
(b) creation of a plurality of buyer accounts on said verification authority system,
(c) creation of a plurality of payee accounts on said verification authority system,
(d) validation of said sales account, buyer account or payee account via a verifyable financial account number
(e) creating a plurality of merchantable works on said verification authority system and assigning each said merchantable work a plurality of royalties associated with their respective payee account,
(f) registering a plurality of files via a seller server application with said verification authority, and associating each file with said seller server application's respective sales account and said merchantable work identity,
(g) performing a merchantable work search via the verification authority,
(h) receiving results from said merchantable work search composed of a plurality of seller server descriptions including at least, mtotal price for each respective file in the set of results of said erchantable work search,
(i) notifying said seller server application of the intent to purchase via a purchase request and a transaction contract,
(j) agreeing on said transaction contract and transferring a file associated with said merchantable work via said communication network from said seller server application to said buyer client application,
(k) said verification authority disbursing royalties from said buyer account to all registered payee accounts contained in said transaction contract.

12. The method of claim 11 wherein validation of said buyer account, seller account or payee account in step d comprises said participant entering their credit card account information or banking account information,
whereby an account can be trusted if it is backed by a financial entity such as a bank.

13. The method of claim 12 wherein said registration and said pricing information in step e is performed by the creator of said merchantable work,
whereby a creator of a merchantable work may set the royalty price independent of said seller server application's transmission fee.

14. The method of claim 13 wherein said transferred file in step j is embedded with a digital receipt of sale,
whereby a buyer client application is incentivized to not re-distribute said transferred file because it contains personally identifying information.

15. The method of claim 14 wherein a file purchased via said communication network is cleared of all digital receipts before it is re-sold on said communication network.

16. The method of claim 15 further comprising:
(l) said buyer, after having purchased said file associated with said merchantable work via said communication network, re-selling said file to other buyers on said communication network,
whereby participants on said communication network are incentivized for re-distributing files by being remunerated and creators are aided in distributing large digital files using peer-to-peer technology.

17. The method of claim 16 wherein said file associated with said merchantable work is a digital audio file.

18. The method of claim 16 wherein said file associated with said merchantable work is a video file.

19. The method of claim 16 wherein said file associated with said merchantable work is a binary executable computer program.

20. The method of claim 16 wherein said file associated with said merchantable work is a an electronic book.
